(19) United States
(12) Patent Application Publication
(10) Pub. No.: US 2006/0051531 A1
(43) Pub. Date: Mar. 9, 2006

(54) Ink-jet recording sheet

(75) Inventor: Shinsaku Kashiwamura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/219,571

(22) Filed: Sep. 1, 2005

(30) Foreign Application Priority Data
Sep. 9, 2004 (JP) JP2004-262146

(51) Int. Cl. B41M 5/00

(52) U.S. Cl. 428/32.34

(57) ABSTRACT

An ink-jet recording sheet having high glossiness and high anti-cracking ability without increasing in the viscosity of the coating liquid in the course of the production can be provided by the ink-jet recording sheet comprising a non-water absorbable support and, provided thereon, a porous layer or porous layers containing a hydrophilic binder and an inorganic fine particle having an average particle diameter of not more than 100 nm, in which at least one porous layer contains a polyoxyethylene-polyooxypropylene copolymer in which a relation of 0.1≦m/(m+n)≦0.5 is satisfied, m is an average addition mole number of ethylene oxide and n is an average addition mole number of propylene oxide, and one of the terminals of the copolymer is substituted by a saturated aliphatic alkyl ether group having 2 to 8 carbon atoms.

### BACKGROUND

1. Field of the Invention

The present invention relates to an ink-jet recording sheet, hereinafter referred to as a recording sheet, and relates in detail to an ink-jet recording sheet which has high glossiness and is improved in the anti-cracking ability, and the viscosity of the coating liquid therefore is not caused in the production course.

2. Description of the Related Art

Recently, progress in the ink-jet technology is considerable so that the image quality is almost the same as that of usual photograph. In the ink-jet recording, it is necessary for obtaining the image quality near usual photograph that the ink-jet recording sheet has high ink absorbability and high glossiness because remarkable lowering in the image quality tens to be caused by occurrence of image unevenness by repelling each another of ink droplets on the recording sheet or spreading of colors at the border of the different colors on the occasion of recording by overlapping two or more colors of ink droplets. A type of ink-jet recording sheet in which a porous layer is provided on a support having high smoothness is superior in the ink absorbability and rapid drying ability. Recently, such the recording sheet comprising a highly smooth support and a porous layer provided thereon has been employed.

When ordinary paper, high quality paper, usual coated paper or cast coated paper is employed for the support, the quality of the printed image is generally lowered by occurrence of wrinkles at the image area after the printing since the ink is permeated into the support. Consequently, ink-jet recording sheet prepared by providing an ink absorbing layer on a support having no or low absorbing ability to the solvent of the aqueous ink, for example, ink-jet recording sheet composed of a photographic support, particularly a photographic support composed of a paper support covered with polyolefin on the both sides and the ink absorbing layer provided thereon, or that composing white plastic film on which the ink absorbing layer is coated is preferably employed for obtaining image quality with high class feeling such as a photograph and material feeling of the printed image. The former type support is described in, for example, IBM Technical Disclosure Bulletin vol. 21, No. 6, p. 2502, 1978, U.S. Pat. No. 3,889,270, and Tokkai Hei 7-179032 and 7-179025, and the later type support is described in, for example, Tokkai Sho 61-135783.

However, the ink absorbability is insufficient and the absorbing capacity is also reduced when the coating amount is small since the support itself almost does not absorb the solvent of the ink even though the dye is held on the surface of the ink-jet recording sheet so that an image tends to be obtained which is satisfactory in the density of printed dots, image density, color cast, clearness, anti-feathering ability and anti-back permeation ability. The increasing in the coating amount as the countermeasure of the above problems causes a tendency of increasing in the occurrence of cracking on the coated layer.

Besides, in a porous type ink-jet recording sheet without post-treatment such as a casting treatment, it is preferable that the diameter of inorganic particles is smaller for obtaining high glossiness. However, the occurrence of crack on the coated layer tends to be increased by the use of such the small diameter inorganic particles. Consequently, a means for improving the crack occurrence is required for the ink-jet recording sheet prepared by providing a porous layer on a non-water absorbable support.

Tokkai Hei 7-137434 proposes ink-jet recording sheet having an ink accepting layer composition mainly comprising inorganic particles having an average particle diameter of less than 0.1 μm and binder and containing a nonionic surfactant having a HLB value of not less than 15. Polyoxyethylene type compounds are disclosed in example described in Patent Document 1, these compounds cause a bad influence on the production efficiency since the viscosity of the coating liquid is increased by their high hydrophilicity even though they are effective in the anti-cracking ability.

Tokkai 2003-80830 proposes ink-jet recording sheet composed of a substrate and a cast layer containing a pigment and a binder, in which polyoxyethylene-polyoxypropylene lauryl ether having an average molecular weight of from 500 to 5,000 is contained. When such the compound having an alkyl ether group containing so large number of carbon atoms as 12 is used, the anti-cracking ability is insufficient in the ink-jet recording sheet without any casting treatment. Tokkai 2003-276312 proposes an ink-jet recording sheet composed of a support, an ink absorbing layer and a layer to be glossy by casting treatment which are laminated on one side of the support, in which polyoxyethylene-polyoxypropylene monobutyl ether is contained. However, this technology is different from the present invention in the object and constitution since silica having a particle diameter of 8 μm is employed in example of the disclosure and the glossiness is made by the casting treatment even though the ink absorbability, glossiness and strength of the coated layer are improved.

### SUMMARY OF THE INVENTION

The invention is attained on the above background, and an object of the invention is to provide an ink-jet recording sheet which has high glossiness and is improved anti-cracking ability, and the viscosity of the coating liquid is not increased in the producing course.

These and other objects are attained by an ink-jet recording sheet comprising a non-water absorbable support and, provided thereon, a porous layer or porous layers containing a hydrophilic binder and inorganic particles having an average particle diameter of not more than 100 nm, wherein at least one porous layer contains a copolymer of polyoxyethylene-polyoxypropylene which satisfies a relation of 0.1≦m/(m+n)≦0.5, in which m is an average addition mole number of ethylene oxide and n is an average addition mole number of propylene oxide, and a terminal of the copolymer is substituted by a saturated aliphatic alkyl ether group.

The invention itself, together with further objects and attendant advantages, will best be understood by reference to the following detailed description.

### DESCRIPTION OF THE PREFERRED EMBODIMENT

The best embodiment of the invention is described in detail below.

As a result of the investigation by the inventors, it is found that the ink-jet recording sheet having high glossiness and improved anti-cracking ability, and the viscosity of the coating liquid is not increased in the production course, can be realized by an ink-jet recording sheet comprising a non-water absorbable support and, provided thereon, a porous layer or porous layers containing a hydrophilic binder and inorganic particles having an average particle diameter of not more than 100 nm, in which at least one porous layer contains a copolymer of polyoxyethylene-polyoxypropylene which satisfies a relation of 0.1≦m/(m+n)≦0.5, in which m is an average addition mole number of ethylene oxide and n is an average addition mole number of propylene oxide, and a terminal of the copolymer is substituted by a saturated aliphatic alkyl ether group.

The ink-jet recording according to the invention is described below.

As above-described, the ink-jet recording sheet according to the invention is characterized in that at least one porous layer contains the polyoxyethylene-polyoxypropylene copolymer.

The polyoxyethylene-polyoxypropylene copolymer relating to the invention is a saturated aliphatic alkyl alcohol added with ethylene oxide and propylene oxide, and the addition may be a block addition, a random addition and their combination, and preferably the random addition. The polyoxyethylene-polyoxypropylene copolymer relating to the invention can be represented by the following Formula 1.
RO—(CH₂CH₂O)ₘ—(CH₂CH₂CH₂O)ₙ—H Formula 1

In the formula, m is addition mole number of ethylene oxide and n is addition mole number of propylene oxide, and 0.1≦m/(m+n)≦0.5, and preferably 0.3≦m/(m+n)≦0.5. One of the terminals of the copolymer is substituted by R; R is a saturated aliphatic alkyl group having carbon atoms of from 2 to 8.

The saturated aliphatic alkyl group may be a straight chain or a branched chain, the number of carbon atom is from 2 to 8, preferably from 4 to 8, and more preferably from 4 to 6. The average molecular weight is preferably from 500 to 1,500, and more preferably from 500 to 1,000. By such the compound, the ink-jet recording sheet improved in the anti-cracking ability without increasing in the viscosity of the coating liquid can be obtained.

It is preferable from the viewpoint of enhancing the effects of the invention that the polyoxyethylene-polyoxypropylene copolymer is contained in the ink-jet recording sheet according to the invention in a weight ration to the later-mentioned inorganic particles of from 0.1 to 10%. It is particularly preferable for improving the anti-cracking ability that the ink-jet recording sheet contains the polyoxyethylene-polyoxypropylene copolymer in a weight ratio to the inorganic particles of from 3 to 8%.

Any known transparent and opaque supports can be employed for the non-water absorbable support of the recording sheet according to the invention. Examples of the support include a transparent support such as a polyester type film, a diacetate type film, a triacetate type film, an acrylate type film, a polycarbonate type film, a poly(vinyl chloride) type film, a polyimide type film, a film composed of cellophane or celluloid, and a translucent or opaque support such as a resin coated paper so-called as RC paper composed of a raw paper having a polyolefin resin layer containing a white pigment provided on at least one side of the paper and a white PET film composed of polyethylene terephthalate added with a white pigment such as titanium oxide and barium sulfate.

The above supports are preferably subjected to a corona discharge treatment or subbing treatment for strengthening the adhesion between the support surface and the coated layer. A tinted support may be employed since the recording sheet produced according to the invention is not always to be colorless.

The support preferably employed in the embodiment of the invention is a transparent polyester film, an opaque polyester film, an opaque polyolefin resin film and a paper support composed raw paper coated with polyethylene on the both sides thereof.

The paper support composed raw paper coated with polyethylene on the both sides is particularly preferred, which are described in detail below.

The raw paper to be employed in the paper support is made mainly from wood pulp and additionally synthesized pulp such as polypropylene or synthesized fiber such as nylon and polyester according to necessity. Any wood pulp such as LBPK, LBSP, NBKP, NBSP, LDP, NSP, LUKP and NUKP can be employed, and LBKP, NBSP, LBSP, NDP and LDP each mostly containing short fiber are preferably used for larger part of the paper. The ratio of LBPS and/or LDP is preferably from 10 to 70% by weight.

As the pulp, chemical pulp such as sulfate pulp and sulfite pulp is preferably employed and pulp subjected to a bleaching treatment for increasing whiteness is also useful.

A sizing agent such as a higher fatty acid and an alkylketene dimer, a white pigment such as calcium carbonate, talk and titanium oxide, a paper strength agent such as starch, polyacrylamide and poly(vinyl alcohol), a fluorescent whitenining agent, a moisture holding agent such as poly(ethylene glycol), a dispersing agent and a softening agent such as a quaternary ammonium may be optionally added into the raw paper.

The drainability of the pulp to be employed is preferably from 200 to 500 ml according to the definition by CSF, and the fiber length after beating represented by the sum of the 24 mesh remaining weight and the 42 mesh remaining weight according to JIS-P-8207 is preferably from 30 to 70%. The 4 mesh remaining weight is preferably not more than 20%.

The weight of the raw paper is preferably from 30 to 250 g, particularly from 50 to 200 g, and the thickness is preferably from 40 to 250 μm.

The raw paper may be subjected to calendar treatment in the course or after the paper making for providing high smoothness. The density of the raw paper is usually from 0.7 to 1.2 g/cm³ (JIS-P-8143). The stiffness of the raw paper is preferably from 20 to 200 g.

A surface sizing agent may be coated on the surface of the raw paper; sizing agents the same as those to be added into the raw paper can be employed for the surface sizing agent.

The pH of the raw paper is preferably from 5 to 9 when it measured by the hot water extraction method defined by JIS-P-8143.

Though polyethylene for covering the surface and back surface of the raw paper is mainly low density polyethylene (LDPE) and/or high density polyethylene (HDPE), another polymer such as LLDPE and polypropylene can be partially employed.

The polyethylene layer provided on the coated layer side surface of the raw paper is preferably one in which rutile or anatase type titanium oxide is added for improving the opacity and whiteness such as that usually employed in photographic paper. The content of the titanium oxide is approximately from 2 to 20%, and preferably from 3 to 13%, in weight ratio to polyethylene.

The polyethylene coated paper can be used as glossy paper, and as matt paper or linen surface paper usually employed in photographic paper prepared by an embossing treatment on the occasion of coating by extruding molten polyethylene onto the raw paper surface.

The using amount of polyethylene on the surface and the back surface of the raw paper is decided so that the curling under low and high humidity is optimized after coating of the aqueous coating composition and the backing layer. The thickness of the polyethylene layer on the side on which the aqueous coating composition according to the invention is coated is within the range of from 20 to 40 μm and that on the back side is within the range of from 20 to 50 μm.

The foregoing polyethylene coated paper preferably has the following properties.

1) Tencil strength: preferably from 20 to 300 N in the lengthwise direction and from 10 to 200 N in the widthwise direction according to the strength defined in JIS-P-8113.

2) Tear strength: preferably from 0.1 to 2 kg in the lengthwise direction and from 0.2 to 2 kg in the widthwise direction according to the strength defined in JIS-P-8116.

3) Compression elasticity: ≧1.01×10⁵ Pa

4) Beck's surface smoothness: preferably not less than 20 seconds under the condition defined in JIS-P-8119 for glossy surface but may be lower than that for embossed paper. The Beck's smoothness of the back surface is not limited, but approximately from 20 to 5,000 is preferable.

5) Opacity: the transmittance of the visual light measured under the condition of specular incident light/diffused permeation light is preferably not more than 20%, and particularly not more than 15%.

Inorganic particle to be contained in the porous layer according to the invention is described below.

Examples of the inorganic fine particle to be employed in the invention include a white pigment such as light calcium carbonate, heavy calcium carbonate, magnesium carbonate, kaolin, clay, talk, calcium sulfate, barium sulfate, titanium dioxide, zinc oxide, zinc hydroxide, zinc sulfide, zinc carbonate, hydrotalcite, aluminum silicate, diatomite, calcium silicate, magnesium silicate, synthesized amorphous silica, colloidal silica, alumina, colloidal alumina, p-boemite, aluminum hydroxide, lithopone, zeolite and magnesium hydroxide, and silica and aluminosilicate having meso-pores which is synthesized by utilizing a surfactant as a template described in “Biryushi Kogaku Taikei Fine Particle Engineering System)”, Vol. 2, p. 463.

The foregoing inorganic fine particles either may be employed in a primary particle state or a secondary coagulated state. In this invention, in case that inorganic fine particles are employed in a secondarily coagulated state, ‘an average particle diameter’ means an average diameter of a secondary coagulated particles.

The average particle diameter of the inorganic fine particles is necessarily to be not more than 100 nm, for obtaining high glossiness. When the average diameter is not less than 10 nm, suitable ink absorbing ability can be easily obtained. When the average diameter of the inorganic fine particles exceeds 100 nm, desired glossiness is difficultly obtained. The average diameter of the inorganic fine particles is defined by simple average of diameters of 100 particles measured by electron microscopic observation on the cross section or the surface of the porous layer. The diameter of each of the particles is represented by the diameter of circle having an area the same as the projection area of the particle.

In the recording sheet of the invention, hydrophilic binders each to be employed in combination with the foregoing inorganic fine particle are, for example, poly(vinyl alcohol) and its derivatives, poly(alkylene oxide), poly(vinyl pyrrolidone), gelatin and its derivatives, hydroxylethyl cellulose, carboxylmethyl cellulose, pullulan, casein and dextran. A hydrophilic binder having low swelling ability and dissolving ability to a high-boiling solvent or water contained in the ink is preferably employed from the viewpoint of the strength of the layer just after printing. In the invention, a polymer compound crosslinked by irradiation of ionized radiation is preferable.

The polymer compound crosslinked by the irradiation of the ionizing radiation employed in the invention is a water-soluble resin capable of crosslinking by reaction caused by irradiation of ionized radiation such as ultraviolet rays and electron rays, which is water soluble before the crosslinking reaction and becomes substantially water-insoluble after the crosslinking reaction. Such the resin has hydrophilicity after the crosslinking reaction and holds sufficient affinity with the ink.

Such the resin is one selected from the group consisting of a saponification product of poly(vinyl acetate), poly(vinyl acetal), poly(alkylene oxide), poly(vinyl pyrrolidone), polyacrylamide, hydroxyethyl cellulose, methyl cellulose, hydroxypropyl cellulose, a derivative of the foregoing hydrophilic resin, and a copolymer of the foregoing resins, and a resin modified by a modifying group such as a photodimerization type, a photodecomposition type, a Photopolymerization type, a photo-modification type and a photodepolymerization type. Among them, the hydrophilic resin modified by the photodimerization type modifying group or the Photopolymerization type modifying group is preferable from the viewpoint of the sensitivity, stability of the resin itself and the binder property of difficultly occurring cracks.

As the photodimerization type modifying group, one having a diazo group, a cinnamoyl group, a styrylpiridinium group or a styrylquinolium group is preferable, and a resin capable of being dyed after the photodimerization by a water-soluble dye such as an anionic dye is also preferable. Examples of such the resin are a resin having a cationic group such as primary amino to quaternary ammonium group, for example, photosensitive resins (compositions) described in Tokkai Sho 62-2833339, Tokkai Hei 1-198615, Tokkai Sho 60-252341, Tokkai Sho 65-57309 and Tokkai Sho 60-129742, and a resin having a group capable of becoming a cationic after the hardening such as an azide group which becomes an amino group by a hardening treatment such as photosensitive resins described in Tokkai Sho 56-67309.

In the invention, the hydrophilic resin capable of being crosslinked by the ionizing radiation is preferably a photo-energy hardenable poly(vinyl alcohol).

In concrete, the following compounds are employable, but the invention is not limited to them.

The photosensitive resins described in Tokkai Sho 56-67309 are resin compositions composed of poly(vinyl alcohol) having a 2-azide-5-nitrophenylcarbonyloxyethylene structure represented by the following Formula I. 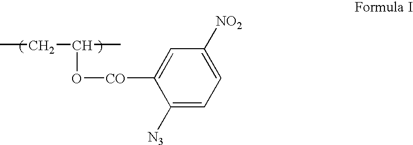
or a 4-azide-3-nitrophenylcarbonyloxyethylene structure represented by the following Formula II.

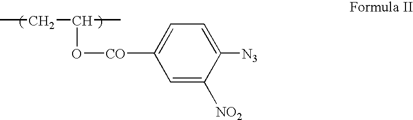

Concrete examples of the photosensitive resin are described in Examples 1 and 2, and the ingredients and the ratio of them are described on page 2 of the above patent document.

Tokkai Sho 60-129742 discloses a photosensitive resin of poly(vinyl alcohol) having the structure represented by Formula III or Formula IV in the molecular structure thereof.

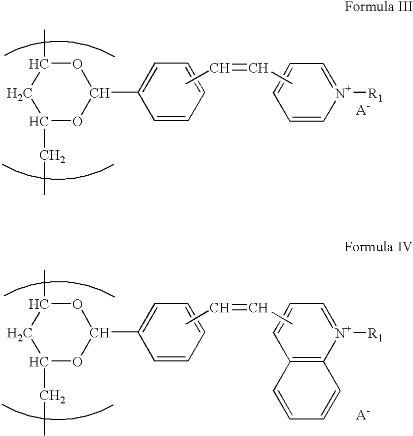

In the invention, a saponification product of poly(vinyl acetate) having a structural unit represented by the following Formula A disclosed in Tokkai 2000-181062 is preferable from the viewpoint of the reactivity.

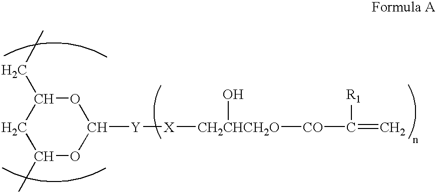

In the above Formula A, R₁ is a hydrogen atom or a methyl group, Y is an aromatic ring or a simple bonding, X is a —(CH₂)ₘ—COO— group, an —O—CH₂—COO— group or an —O— atom, and m is an integer of from 0 to 6 and n is 1 or 2.

In the invention, a photoreaction initiator and a sensitizer are preferably added together with the hydrophilic binder containing a polymer polymerized by the irradiation of the ionizing radiation. These compounds may be added in a state of dissolved or dispersed in a solvent, or chemically bonded with the hydrophilic binder containing the above polymerized compound.

Known photoreaction initiators and the photosensitizers can be employed without any limitation. Examples of those include a benzophenone such as benzophenone, hydroxybenzophenone, bis-N,N-dimethylaminobenzophenone, bis-N,N-diethylaminobenzophenone and 4-methoxy-4′-dimethylaminobenzophenone, a thioxantone such as thioxantone, 2,4-diethylthioxantone, isopropylthioxantone, chlorothioxantone and isopropoxychlorothioxantone, an anthraquinone such as ethylanthraquinone, benzanthraquinone, aminoanthraquinone and chloroanthraquinone, an acetophenone, a benzoin ether such as benzoin methyl ether, a 2,4,6-trihalomethyltriazine, 1-hydroxycyclohexyl phenyl ketone, 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-phenylimidazole dimer, 2-(o-methoxyphenyl)-4,5-diphenylimidazole dimer, 2-di(p-methoxyphenyl)-5-phenylimidazole dimer, 2,4,5-triarylimidazole dimer of 2-(2,4-dimethoxyphenyl)-4,5-diphenylimidazole dimer, benzyl dimethyl ketal, 2-benzyl-2-dimethylamino-1-(4-morpholinophenyl)-butane-1-one, 2-methyl-1-[4-(methylthio)phenyl]-2-morpholino-1-propanone, 2-hydroxy-2-methyl-1-phenyl-propane-1-one, 1-[4-(2-hydroxyethoxy)-phneyl]-2-hydroxy-2-methyl-l-propane-l-one, phenanthrenequinone, 9,10-phenanthrenequinone, a benzoin such as methylbenzoin and ethylbenzoin, an acrydine derivative such as 9-phenylacrydine and 1,7-bis(9,9′-acrydinyl)heptane, bisacylphosphine oxide, and a mixture of the above-mentioned. The above compounds may be employed singly or in combination.

A water-soluble initiator such as 1-[4-(hydroxyethoxy)-phenyl]2-hydroxy-2-methyl-1-propane-1-one, 4-(2-hydroxyethoxy)-phenyl-(2-hydroxy-2-propyl) ketone, ammonium salt of thioxantone and ammonium salt of benzophenone is preferred since it is excellent in the mixing ability and the crosslinking effect.

An accelerator may be added additionally to the initiator. Examples of the accelerator include ethyl p-dimethylaminobenzoate, isoamyl p-dimethylaminobenzoate, ethanolamine, diethanolamine and triethanolamine.

In such the resin, the polymerization degree of the poly(vinyl alcohol) as the mother nucleus is preferably not less than 300, and more preferably not less than 1,700. The modifying ratio of the ionizing radiation reactive modifying group to the segment is preferably not more than 4 mole-percent, and more preferably not more than 1 mole-percent. When the polymerization degree of the segment is less than 300 or the modifying ratio exceeds 4 mole-percent, the density of the crosslinks is made too high so that the anti-cracking ability of the dried layer is considerably lowered. When the crosslinking density is excessively high, the balance in the moisture absorbing and the dimension stability to the substrate becomes unsuitable and the curling property is undesirably deteriorated.

When the ionizing radiation hardenable polymer is used in the production method of the ink-jet recording sheet according to the invention, a coating liquid containing the ionizing radiation hardenable polymer is coated and ionizing radiation is irradiated at a time when the total solid content of the coated layer is made to 5 to 90% for gelling the coated layer, and then the coated layer is dried. In the invention, electron rays, ultraviolet rays, α-rays, β-rays, γ-rays and X-rays are applicable as the ionizing radiation, and electron rays and ultraviolet rays are preferable since these rays are easily handled without dangerousness to human body and spread in the industrial use.

For example, a scanning method, a curtain beam method and broad beam method are applicable for irradiating the electron rays, and the curtain beam method is preferable from the viewpoint of the treatment capacity. The acceleration voltage of the electron rays is suitably from 20 kV to 300 kV, though the voltage can be varied according to the density and the thickness of the coated layer. The irradiation amount of the electron rays is preferably from 0.1 to 20 Mrad.

As the source of ultraviolet rays, a low, medium or high pressure mercury lamp with a working pressured of from 100 Pa to 1 MPa and a metal halide lamp are usable. The high pressure mercury lamp and the metal halide lamp are preferable from the viewpoint of the wavelength distribution of the emitted light, and the metal halide lamp is more preferable.

When ultraviolet rays contain ray having a wavelength of not more than 300 nm or the irradiation energy exceeds 100 J/cm², the mother nucleus of the ionizing radiation crosslinkable resin or the various additives coexisting with the resin are decomposed so that the effects of the invention cannot be obtained and a possibility of occurrence of bad odor is caused. When the irradiation energy is lower than 0.1 mJ/cm², the formation of the crosslinks becomes insufficient so that the effects of the invention cannot be sufficiently obtained. Consequently, the light source is preferably provided a filter for cutting light of 300 nm or less and has an output of the lamp is preferably from 400 W to 30 kW and an illuminance is preferably from 10 mW/cm² to 10 kW/cm². In the invention, the irradiation energy is preferably from 0.1 mJ/cm² to 100 mJ/cm², more preferably from 1 mJ/cm² to 50 mJ/cm².

The existence of the preferable range on the illuminance of the light with respect to the same exposure amount is caused by the variation in the light transmittance of the resin layer. The concentration distribution of the formed crosslinking species is varied depending on the transmittance of the ultraviolet rays, and the crosslinking species are formed in high concentration at the surface of the layer when the illuminance of the ultraviolet rays is high so that a hard and high dense layer is formed at the surface of the coated layer. When the illuminance is within the preferable range, the degree of crosslinking at the surface is low and loose crosslinkings are uniformly formed toward the depth direction of the layer because the light transmittance toward the depth direction is high. When the illuminance is excessively low, large irradiation time is required for giving the necessary exposing amount that is disadvantage in the cost for the production equipment and the absolute light amount is undesirably made insufficient by the scatter of the ultraviolet rays.

The ratio of the inorganic fine particles to the hydrophilic binder in the ink absorbing layer is preferably 2 to 20 by weight. When the ratio is not less than 2, the porous layer having sufficient porosity can be obtained and the blocking of the pores by the swelling of the hydrophilic binder on the occasion of the ink-jet recording is not caused so that the high ink absorbing rate can be obtained. Besides, when the ratio is not more than 20, the cracks are difficultly caused on the occasion of coating a thick ink absorbing layer. The particularly preferable ratio of the inorganic fine particles to the hydrophilic binder is from 3 to 10 times, more preferably from 4 to 10 times and most preferable from 4.5 to 10 times.

The content of the inorganic fine particles in the aqueous coating liquid is from 5 to 40%, and preferably from 7 to 30%, by weight. The inorganic fine particles are preferably contained in the ink receiving layer in an amount of from 10 to 50 g/m², more preferably from 15 to 30 g/m², for forming the ink absorbing layer having satisfactory ink absorbing ability and anti-cracking ability.

Various additives may be added to the aqueous coating liquid for forming the porous layer according to the invention or another layer coating liquid. Examples of such the additive include a cationic mordant, a poly-valent metal compound, an organic latex particle such as polystyrene, a polyacrylate, a polymethacrylate, a polyacrylamide, polyethylene, polypropylene, poly(vinyl chloride), poly(vinylidene chloride), and a copolymer thereof, urea resin and melamine resin, an anionic, cationic, nonionic and amphoteric surfactant, a UV absorbent described in Tokkai Sho 57-74193, 57-87988 and 62-261476, an anti-fading agent described in Tokkai Sho 57-74192, 57-87989, 60-72785 and 61-146591, and Tokkai Hei 1-95091 and 3-13376, a fluorescent whitening agent described in Tokkai Sho 59-42993, 59-52689, 62-280069 and 61-242871, and Tokkai Hei 4-219266, a pH buffer such as sulfuric acid, phosphoric acid, citric acid, sodium hydroxide, potassium hydroxide and potassium carbonate, an antifoaming agent, a preservative, a thickner, an antistatic agent and a matting agent.

As the mordant, polymer mordants each having a primary to tertiary amino group or a quaternary ammonium salt group is usable, and the polymer mordants having a quaternary salt group are preferable since discoloring and degradation in the light fastness during the storage for a prolonged period are small. Preferable polymer mordant is a homopolymer of a monomer having the quaternary ammonium salt group or co-polymer or condensate polymer of the monomer with another monomer.

A salt of metal such as aluminum, calcium, magnesium, zinc, iron, zirconium, tin and lead is employable as the poly-valent metal compound. Among them compounds of magnesium, aluminum, zirconium, calcium or zinc are preferable since they are colorless. A water-soluble inorganic polymer such as poly(aluminum chloride) may also be usable.

The adding amount of the cationic polymer or the water-soluble poly-valent metal compound is preferably not more than 10%, and more preferably not more than 8%, in the weight ratio to the inorganic fine particles, for avoiding the deterioration of the ink absorbing ability.

The cationic polymer or the poly-valent metal compound may be added by a method in which such the compound is directly added to the coating liquid and coated or a method in which an aqueous solution of the compound is over coated and dried on the recording medium after coating and drying thereof.

A hardener for the water-soluble binder forming the porous layer is preferably added to the ink-jet recording sheet of the invention.

Boric acid and its salts are preferable as the hardener, though any compound capable of causing hardening reaction with the water-soluble binder are employable without any limitation. Another known compound can be employed, which are generally a compound having a group capable of reacting with the water-soluble binder or a compound capable of accelerating the reaction between different groups contained in the water-soluble binder, which are optionally selected according to the kind of the water-soluble binder. Concrete example of the hardener include an epoxy type hardener such as diglycidyl ethyl ether, ethylene glycol diglycidyl ether, 1,4-butanediol diglycidyl ether, 1,6-diglycidylcyclohexane, N,N-diglycidyl-4-glycidyloxyaniline, sorbitol diglycidyl ether and glycerol polyglycidyl ether, an aldehyde type hardener such as formaldehyde and glyoxal, an active halogen type hardener such as 2,4-dichloro-4-hydroxy-1,3,5-s-triazine, an active vinyl type compound such as 1,3,5-trisacroyl-hexahydro-s-triazine and bis-vinylsulfonyl methyl ether, and aluminum alum.

Boric acid and its salt are an oxygen acid having a boron atom as the central atom and its salt, for example, orthoboric acid, diboric acid, metaboric acid, tetraboric acid, pentaboric acid and octaboric acid and salts thereof.

The boric acid and its salt each having a boron atom may be employed in a state of single aqueous solution or a solution of mixture thereof. An aqueous solution of mixture of boric acid and borax is particularly preferred. Boric acid and borax are respectively can be added only in a state of relative low concentration aqueous solution. However, a mixture of boric acid and borax can be made in a state of relatively high concentration solution so that the coating liquid can be concentrated. Moreover, a merit can be obtained such as that the pH of the solution to be added can be relatively freely controlled. The using amount of the hardener is preferably from 1 to 600 g per gram of the water-soluble binder.

In the recording sheet of the invention, the viscosity of the porous layer coating liquid is preferably from 0.010 to 0.300 Pa.s, more preferably from 0.025 to 0.100 Pa.s, at 40° C. When the viscosity of the coating liquid is too high, supply of the coating liquid to the coating apparatus becomes difficult and troubles on the transportation of liquid are caused.

In the recording sheet of the invention, the method for coating the porous layer according to the invention or another layer on the non-water absorbable support can be optionally selected from known methods. By the preferable method, each layer can be obtained by the coating and drying a liquid for each of the layers on the support. Two or more layers can be simultaneously coated. For example, a roller coating method, a rod bar coating method, an air-knife coating method, a spray coating method, a curtain coating method and an extrusion coating method employing a hopper which is described in U.S. Pat. No. 2,681,294 are preferably applied.

An ink-jet ink, hereinafter referred to as an ink, to be employed for printing an image onto the ink-jet recording sheet of the invention is described below.

An aqueous ink, an oily ink, and a solid (phase changing) ink can be employed as the ink to be applied to the ink-jet recording medium of the invention. The aqueous ink, for example, an aqueous ink-jet recording liquid containing water in an amount of not less than 10% of the entire weight of the ink, is particularly preferably employed.

Known water-soluble dyes such as an acid dye, a direct dye and a reactive dye, a dispersed dye and a pigment can be employed as the colorant in the ink.

In the aqueous ink composition, a water-soluble organic solvent is preferably employed together with water. Examples of the water-soluble organic solvent capable of being employed in the invention include an alcohol such as methanol, ethanol, propanol, isopropanol, butanol, isobutanol, secondary propanol, tertiary butanol, pentanol, hexanol, cyclohexanol, and benzyl alcohol, a poly-valent alcohol such as ethylene glycol, diethylene glycol, triethylene glycol, poly(ethylene glycol), propylene glycol, butylene glycol, hexanediol, pentanediol, glycerol, hexanetriol and thiodiglycol, a poly-valent alcohol ether such as ethylene glycol monomethyl ether, ethylene glycol monoethyl ether, ethylene glycol monobutyl ether, diethylen glycol monomethyl ether, diethylene glycol monomethyl ether, diethylene glycol monobutyl ether, propylene glycol monomethyl ether, propylene glycol monombutyl ether, ethylene glycol monomethyl ether acetate, triethylene glycol monomethyl ether, triethylene glycol monoethyl ether, triethylene glycol monobutyl ether, triethylene glycol monophenyl ether and propylene glycol monophenyl ether, an amine such as ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethlenepentamine, polyethyleneimine, pentamethyldiethylenetriamine and tetramethylpropylenediamine, an amide such as formamide, N,N-dimethylformamide and N,N-dimethylacetamide, a heterocyclic compound such as 2-pyrrolidone, N-methyl-2-pyrrolidone, cyclohexylpyrrolidone, 2-oxazolidone, and 1,3-dimethyl-2-imidazolydinone, a sulfoxide such as dimethylsulfoxide, a sulfone such as sulforan, and urea, acetonitrile and acetone. The polyvalent alcohols are preferable, and the combination use of the polyvalent alcohol and the polyvalent alcohol ether is particularly preferred. The water-soluble organic solvent may be employed singly of in combination of plural kinds thereof. The adding amount of the water-soluble organic solvent in the ink is from 5 to 60% by weigh, preferably from 10 to 35% by weight, in total.

Various kinds of known additive, for example, a viscosity controlling agent, a surface tension controlling agent, a relative resistance controlling agent, a film forming agent, a dispersant, a surfactant, a UV absorbent, an anti-oxidant, an anti-discoloration agent, an anti-mould agent and an anti-stain agent may be added to the ink composition to be employed in the invention according to improving purposes such as of the jetting stability, the suitability for print head or ink cartridge, the storage stability and the storage ability of image. Examples of the additive include an fine latex particle of organic polymer such as polystyrene, a polyacrylate, a polymethacrylate, a polyacrylamide, polyethylene, polypropylene, poly(vinyl chloride), poly(vinylidene chloride), and their copolymer, urea resin and melamine resin, an fine droplet of oil such as liquid paraffin, dioctyl phthalate, tricresyl phosphate and silicone oil, various kinds of cationic and nonionic surfactant, a UV absorbent described in Tokkai Sho 57-74193, 57-87988 and 62-261476, an anti-discoloring agent described in Tokkai Sho 57-74192, 57-87989, 60-72785 and 61-146591, and Tokkai Hei 1-95091 and 3-13376, a fluorescent whitening agent described in Tokkai Sho 59-42993, 59-52689, 62-280069 and 61-242871, and Tokkai Hei 4-219266, and a pH controlling agent such as sulfuric acid, phosphoric acid, citric acid, sodium hydroxide, potassium hydroxide and potassium carbonate.

The viscosity of the ink composition during the flying is preferably not more than 40 mPa.s, and more preferably not more than 30 mPa.s. The surface tension of the ink composition during the flying is preferably not less than 20 mN/m, and more preferably from 30 to 40 mN/m.

### EXAMPLES

The invention is described in detail below referring examples, but the invention is not limited to the examples. In the description of the examples, “%” represents “% by weight” except that a specific comment is attached.

<<Preparation of Recording Sheet>>

<Preparation of Recording Sheet 1>

Preparation of Porous Layer Coating Liquid 1

To 400 g of a 23% dispersion A1 (pH: 2.8, containing ethanol in an amount of 1%) of previously dispersed gas-method silica (Aerosil 300, manufactured by Nihon Aerosil Co., Ltd., the average particle diameter in a primary particle state is 7 nm, the average particle diameter in a secondary coagulated state is 36 nm), 112 g of a 10% aqueous solution (containing 10% by weight of n-propanol and 2% by weight of ethanol) of cationic polymer PH-1, and 69 ml of aqueous solution of 2.1 g of boric acid and 1.5 g of borax were added and pre-dispersed by a dissolver. The pre-dispersed mixture was dispersed by as sand mill for 30 minutes with a circumference speed of 9 m/second. The resultant dispersion was made up to 630 ml in total and then filtered through TCP-10 type filter, manufactured by Advantex-Toyo Co., Ltd. Thus a almost transparent dispersion B1 was obtained.

To 615 ml of the dispersion B1, 267 ml of a 6% aqueous solution of poly(vinyl alcohol), PVA-253 manufactured by Kraray CO., Ltd., and 3 g of a polyoxyethylene-polyoxypropylene compound Pionin P-0735-B having a (m/m+n) value of 0.35, a carbon number in ether group of 4, and an average molecular weight of 700, manufactured by Takemoto Yushi Co., Ltd., were added and the purified water added so that the total volume of the liquid was made to 1,000 ml. Thus translucent porous layer coating liquid 1 was obtained.

Cationic polymer HP-1

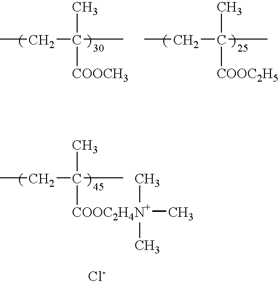

Preparation of Recording Sheet

On the recording surface side of a support, the above-obtained porous layer coating liquid 1 was coated in a wet thickness of 190 μm and cooled for 20 seconds at 5° C., and then dried by air of 65° C. to prepare Recording Sheet 1. The coated amount of silica is 17 g/m². The support was composed of a raw paper having a weight of 180 g/m², and coated with polyethylene on the both sides thereof, which had a thickness of 250 μm and the polyethylene layer on the recording surface had a thickness of 35 μm and contained 6% by weight of anatase type titanium oxide, and the polyethylene layer on the backside had a thickness of 25 μm.

Preparation of Recording Sheet 2

Recording Sheet 2 was prepared in the same manner as in Recording Sheet 1 except that Pionin P-0735-B in the porous layer coating liquid 1 was replaced by 3 g of Pionin-0550-B having a m/(m+n) value of 0.50, a carbon number in alkyl ether group of 4 and an average molecular weight of 500, manufactured by Takemoto Yushi Co., Ltd.

Preparation of Recording Sheet 3

Recording Sheet 3 was prepared in the same manner as in Recording Sheet 1 except that the amount of Pionin P-0735-B in the porous layer coating liquid was changed to 9 g.

Preparation of Recording Sheet 4

Recording Sheet 4 was prepared in the same manner as in Recording Sheet 1 except that the amount of Pionin P-0735-B in the porous layer coating liquid was changed to 14 g.

Preparation of Recording Sheet 5

Recording Sheet 5 was prepared in the same manner as in Recording Sheet 1 except that the gas-method silica was replaced by wet-method silica X-37, manufactured by Tokuyama Co., Ltd.

The wet-method silica was continuously dispersed together with the aqueous medium by a continuous type pin mixer Flow Jet mixer 300, manufactured by Funken-Powtech Co., Ltd., and a high speed rotation type continuous disperser Flow Fine Mill FM25, manufactured by Taiheiyou Kikou Co., Ltd., to prepare a pre-dispersed liquid. The above aqueous medium contained boric acid and the cationic polymer HP-1. The silica concentration in the pre-dispersed liquid was 30%. The added amount of boric acid was 2.7% by weight of the silica and that of P-9 was 10% by weight of the silica.

The pre-dispersed liquid was dispersed by a sand mill disperser RL-125, manufactured by Ashizawa Co., Ltd., and filtered to prepare dispersion. The average particle diameter of the silica in a secondarily coagulated state was 150 nm.

Preparation of Recording Sheet 6

Recording Sheet 6 was prepared in the same manner as in Recording Sheet 1 except that Pionin P-0735-B in the porous layer coating liquid 1 was replaced by 3 g of Pionin-1560-B having a m/(m+n) value of 0.60, a carbon number in alkyl ether group of 4 and an average molecular weight of 1,500, manufactured by Takemoto Yushi Co., Ltd.

Preparation of Recording Sheet 7

Recording Sheet 7 was prepared in the same manner as in Recording Sheet 1 except that Pionin P-0735-B in the porous layer coating liquid 1 was replaced by 3 g of Pionin-1340-O having a m/(m+n) value of 0.40, a carbon number in alkyl ether group of 8 and an average molecular weight of 1,300, manufactured by Takemoto Yushi Co., Ltd.

Preparation of Recording Sheet 8

Recording Sheet 8 was prepared in the same manner as in Recording Sheet 1 except that Pionin P-0735-B in the porous layer coating liquid 1 was replaced by 3 g of Pionin-2765-O having a m/(m+n) value of 0.65, a carbon number in alkyl ether group of 8 and an average molecular weight of 2,700, manufactured by Takemoto Yushi Co., Ltd.

Preparation of Recording Sheet 9

Recording Sheet 9 was prepared in the same manner as in Recording Sheet 1 except that Pionin P-0735-B in the porous layer coating liquid 1 was replaced by 3 g of Pionin-1130-L having a m/(m+n) value of 0.30, a carbon number in alkyl ether group of 12 and an average molecular weight of 1,100, manufactured by Takemoto Yushi Co., Ltd.

Preparation of Recording Sheet 10

Recording Sheet 10 was prepared in the same manner as in Recording Sheet 1 except that Pionin P-0735-B in the porous layer coating liquid 1 was replaced by 3 g of polyethylene glycol 600 having a m/(m+n) value of 0, a carbon number in alkyl ether group of 0 and an average molecular weight of 600, manufactured by Kanto Kagaku Co., Ltd.

Preparation of Recording Sheet 11

Recording Sheet 11 was prepared in the same manner as in Recording Sheet 1 except that Pionin P-0735-B in the porous layer coating liquid 1 was replaced by 3 g of polypropylene glycol 425 having a m/(m+n) value of 0, a carbon number in alkyl ether group of 0 and an average molecular weight of 425, manufactured by Kanto Kagaku Co., Ltd.

Preparation of Recording Sheet 12

Recording Sheet 10 was prepared in the same manner as in Recording Sheet 1 except that Pionin P-0735-B in the porous layer coating liquid 1 was replaced by 3 g of surfactant S-1.

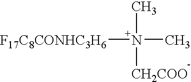

Preparation of Recording Sheet 13

Preparation of Porous Layer Coating Liquid 2

To 400 g of silica dispersion (having a pH of 2.8 and containing 1% by weight of ethanol) containing 23% of previously uniformly dispersed gas-method silica having an average particle diameter in a primary particle state of approximately 7 nm and an average particle diameter in a secondary coagulated state of 39 nm, 112 g of a 10% aqueous solution of cationic polymer HP-1 containing 10% by weight of n-propanol and 2% by weight of ethanol was added while stirring at a room temperature, and then the pH of the liquid was adjusted to 4.1 by a 1 mole/liter solution of sodium hydroxide. The resultant liquid was dispersed by a high pressure homogenizer, manufactured by Sanwa Kogyo Co., Ltd., with a pressure of 3 kN/cm² and then the silica content was adjusted to 15% by adding purified water. After that, the dispersion was filtered through TCP-10 type filter, manufactured by Advantex-Toyo Co., Ltd. Thus an almost transparent dispersion B2 was prepared.

While stirring the 615 ml of the dispersion B2, 160 ml of a 10% aqueous solution of a photo-crosslinkable poly(vinyl alcohol) derivative introduced with styrylpridinium groups was gradually added, and the 3 g of the foregoing Pionin P-0735-B was added-and the total amount-of the liquid was made up to 1,000 ml. The resultant liquid was dispersed by the high pressure homogenizer with a pressure of 3 kN/cm² to prepare a porous layer coating liquid 2.

Preparation of Recording Sheet

Recording Sheet 13 was prepared in the same manner as in Recording Sheet 1 except that the porous layer coating-liquid 1 was replaced by the porous layer coating liquid 2.

Preparation of Recording Sheet 14

Recording Sheet 14 was prepared in the same manner as in Recording Sheet 12 except that Pionin-0735-B in the porous layer coating liquid 2 was replaced by 3 g of Surfactant S-1.

<<Evaluation of Recording Sheet>>

The above-prepared Recording Sheets 1 through 14 were subjected to evaluation according to the following methods.

Evaluation of Anti-Cracking Ability

The porous layer coated surface of each of the recording sheet was observed by a loupe for counting the number of cracks formed per 0.3 m².

Evaluation of Glossiness

The glossiness at 60° of each of the recording sheets was measured by a glossiness meter VGS-1001DP, manufactured by Nihon Denshoku Kogyo Co., Ltd.

Measurement of Viscosity of Porous Layer Coating Liquid

The viscosity at 40° C. of each of the porous layer coating liquids used for each-of the recording sheets was measured by a B-type viscometer, manufactured by Tokyo Keiki Co., Ltd.

Thus obtained results of the evaluations and measurements are listed in Table 1.

TABLE 1

| | Additive for porous layer | | | | | Average | | | | | |
|---|---|---|---|---|---|---|---|---|---|---|---|
| | (Copolymer compound and others) | | | | | particle | | | | | |
| | | | | | Weight | diameter | | Evaluation resul | | | |
| | | | Number | | ratio to | of inorganic | | | | Viscosity | |
| | | | of carbon | | inorganic | fine particles | | | | of | |
| Recording | | | atom in | Average | fine | in a secondary | Hydro- | Anti- | | coating | |
| paper | | m/ | alkyl | molecular | particles | coagulated | philic | cracking | Glossiness | liquid | |
| No. | Compound | (m + n) | chain | weight | (%) | state | binder | ability | at 60° | (Pa · s) | Remarks |
| 1 | P-0735-B | 0.35 | 4 | 700 | 3.3 | 40 | PVA | 7 | 32 | 0.10 | Inv. |
| 2 | P-0550-B | 0.50 | 4 | 500 | 3.3 | 40 | PVA | 5 | 31 | 0.09 | Inv. |
| 3 | P-0735-B | 0.35 | 4 | 700 | 10.0 | 40 | PVA | 7 | 35 | 0.11 | Inv. |
| 4 | P-0735-B | 0.35 | 4 | 700 | 15.0 | 40 | PVA | 8 | 33 | 0.15 | Inv. |
| 5 | P-0735-B | 0.35 | 4 | 700 | 3.3 | 150 | PVA | 5 | 5 | 0.03 | Com. |
| 6 | P-1560-B | 0.60 | 4 | 1500 | 3.3 | 40 | PVA | 22 | 16 | 0.41 | Com. |
| 7 | P-1340-O | 0.40 | 8 | 1300 | 3.3 | 40 | PVA | 6 | 31 | 0.16 | Inv. |
| 8 | P-2765-O | 0.65 | 8 | 2700 | 3.3 | 40 | PVA | 20 | 29 | 0.45 | Com. |
| 9 | P-1130-L | 0.30 | 12 | 1100 | 3.3 | 40 | PVA | 47 | 8 | 0.24 | Com. |
| 10 | *1 | 1.00 | 0 | 600 | 3.3 | 40 | PVA | 24 | 23 | 1.00 | Com. |
| | | | | | | | | | | or more | |
| 11 | *2 | 0 | 0 | 425 | 3.3 | 40 | PVA | 31 | 12 | 0.37 | Com. |
| 12 | Surfactant | — | — | — | 3.3 | 40 | PVA | 34 | 16 | 0.42 | Com. |
| | (S-1) | | | | | | | | | | |
| 13 | P-0735-B | 0.35 | 4 | 700 | 3.3 | 40 | *3 | 8 | 34 | 0.09 | Inv. |
| 14 | Surfactant | — | — | — | 3.3 | 40 | *3 | 44 | 8 | 0.38 | Com. |
| | (S-1) | | | | | | | | | | |

*1: Polyethylene glycol
*2: Polypropylene glycol
*3: Ionizing radiation crosslinking type poly(vinyl Alcohol)
Inv.: Inventive example Com.:
Comparative example
PVA: Poly(vinyl alcohol)

As is cleared in Table 1, high anti-cracking ability and high glossiness can be obtained without increasing in the viscosity of the porous layer coating liquid in the course of the production in the recording sheets satisfying the requirements of the invention compared with the comparative examples. Particularly, considerable degradation in the cracking occurrence caused by the use of the photo-crosslinkable poly(vinyl alcohol) as show in Recording paper 13 is remarkably improved by the compound according to the invention as shown in Recording Sheet 14.

An ink-jet recording sheet having high glossiness and high anti-cracking ability without increasing in the viscosity of the coating liquid in the course of the production can be provided by the invention.

It is to be noted that various changes and modifications will be apparent to those skilled in the art. Therefore, unless such changes and modifications depart from the scope of the present invention, they should be construed as being included therein.

What is claimed is:

1. An ink-jet recording sheet comprising a non-water absorbable support and, provided thereon, a porous layer or porous layers containing a hydrophilic binder and inorganic fine particles having an average particle diameter of not more than 100 nm, wherein at least one porous layer contains a polyoxyethylene-polyooxypropylene copolymer in which a relation of 0.1≦m/(m+n)≦0.5 is satisfied, m is an average addition mole number of ethylene oxide and n is an average addition mole number of propylene oxide, and one of the terminals of the copolymer is substituted by a saturated aliphatic alkyl ether group having 2 to 8 carbon atoms.

2. The ink-jet recording sheet of claim 1, wherein an average molecular weight of the polyoxyethylene-polyoxypropylene copolymer is from 500 to 1,500.

3. The ink-jet recording sheet of claim 1, wherein the polyoxyethylene-polyoxypropylene copolymer is contained in a weight ratio of from 0.1 to 10% to the inorganic fine particles.

4. The ink-jet recording sheet of claim 1, wherein the hydrophilic binder contains a polymer compound crosslinked by irradiation by ionizing radiation.
